(19) United States
(12) Patent Application Publication
(10) Pub. No.: US 2013/0064630 A1
(43) Pub. Date: Mar. 14, 2013

(54) SYSTEM AND APPARATUS FOR LOADING AND UNLOADING COMPRESSED NATURAL GAS STORAGE MODULES

(71) Applicants: John Walton, Cambridge, MA (US); Pedro Santos, Houston, TX (US)

(72) Inventors: John Walton, Cambridge, MA (US); Pedro Santos, Houston, TX (US)

(73) Assignee: Oscomp Systems Inc., Boston, MA (US)

(21) Appl. No.: 13/618,793

(22) Filed: Sep. 14, 2012

Related U.S. Application Data
(60) Provisional application No. 61/534,812, filed on Sep. 14, 2011.

(51) Int. Cl. B65G 67/02; B65G 67/04; B65G 67/24

(52) U.S. Cl. 414/397; 414/809

(57) ABSTRACT

An apparatus for loading and unloading compressed gas storage modules to and from a trailer deck includes two bilateral tracks that the compressed gas storage module can roll on; bridges that rotate about an axis that connects the two bilateral tracks to a trailer deck; and a supporting structure that elevates the two bilateral tracks and bridges to a height that is equal to or higher than a height of the trailer deck.

### CROSS REFERENCE

This application claims the benefit of priority from U.S. Provisional Application No. 61/534,812, filed Sep. 14, 2011, titled “SYSTEM AND APPARATUS FOR LOADING AND UNLOADING COMPRESSED NATURAL GAS STORAGE MODULES,” the entire contents of which are hereby incorporated by reference herein.

### BACKGROUND

The invention generally relates to a system and apparatus for loading and unloading compressed natural gas (CNG) storage modules.

Natural gas can be distributed to areas that do not have access to natural gas pipelines by transporting CNG storage modules to the area via truck, thus creating a “virtual pipeline” system. Once a filled CNG module is transported to its destination, the CNG storage modules must be safely unloaded and replaced by empty storage modules to be transported back to the natural gas source to be filled. Current systems and methods for unloading and loading CNG modules are both expensive and difficult to manage. Previous efforts to reduce the expense and complexity of unloading and loading CNG modules have introduced problems of their own.

### SUMMARY OF EMBODIMENTS OF THE INVENTION

One or more embodiments of the present invention relates to a device that assists in loading and unloading compressed gas (e.g., compressed natural gas (CNG), adsorbed natural gas (ANG), compressed forms of other types of gases, high pressure gases, etc.) storage modules to and from trailers. One or more embodiments of the present invention includes three primary components, i.e., two bilateral tracks that a compressed gas storage module can roll on, bridges that rotate about an axis that connect the tracks to the trailer deck, and a supporting structure that elevates the tracks and bridges to a height that is equal to or higher than the height of the trailer deck.

According to one or more embodiments, during an unloading operation, a compressed gas storage module is laterally rolled from the top of a trailer deck, onto the bridges, and finally onto the tracks. Conversely, according to one or more embodiments, during a loading operation, a compressed gas storage module is rolled from the tracks, onto the bridge, and back onto the trailer deck. This lateral movement can be achieved by an electric or manual winch, hydraulics, or other devices that would give the user a mechanical advantage.

One or more embodiments of the present invention reduces the time needed for loading and unloading compressed gas storage modules to and from trailers, reduces the total work needed during loading and unloading operations due to minimization of the vertical displacement of the compressed gas storage module, and maximizes total gas capacity of the truck by allocating as much allowable mass to the compressed gas storage modules and not equipment required for other means of loading and unloading.

These and other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIGS. 1a and 1b show a four stall configuration of an embodiment of the invention.

FIG. 2 shows a four stall configuration of an embodiment of the invention with four CNG storage modules and a standard flatbed trailer all in a typical arrangement

FIG. 3 shows the three surfaces on which a CNG storage module can roll along with the pivot point of the assembly.

FIGS. 4a and 4b show an alternate bridge design.

FIGS. 5a -5h show the unloading sequence.

### DETAILED DESCRIPTION OF EXEMPLARY EMBODIMENTS OF THE INVENTION

First the apparatus will be described in details and then the process of loading and unloading a compressed natural gas (CNG) storage module.

Apparatus

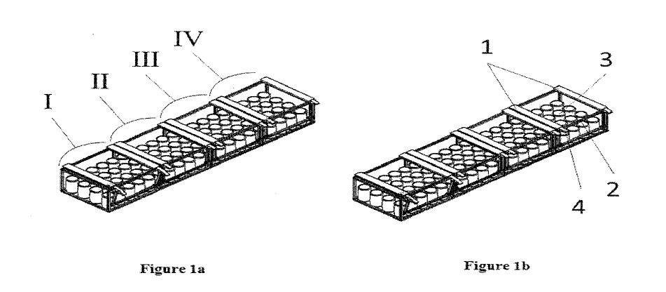

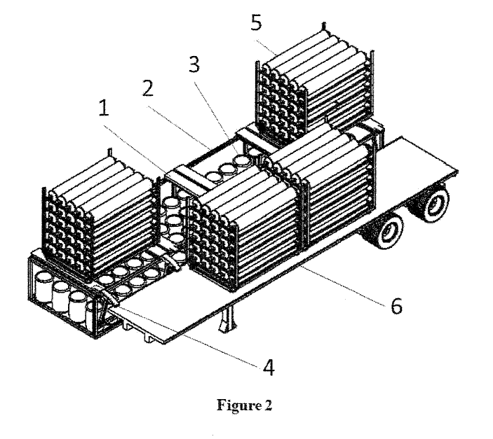

One embodiment of the invention can be seen in FIGS. 1a and 1b. In FIG. 1a, the embodiment has four individual stalls (I, II, III and IV) where a single compressed natural gas (CNG) storage module (5) (shown in FIG. 2) can be unloaded onto and stored. It is important to note that the various embodiments can be at minimum one stall or up to ten stalls or more. A single stall includes two bilateral tracks (1), water containers (3) that increase the mass and lower the center of mass of the apparatus, and a structure (2) that elevates the track's roller surface (8) to a height that is equal to or higher than a trailer's deck (10).

FIG. 2 shows the embodiment with two unloaded compressed natural gas (CNG) storage modules (5) in stalls I and IV and a trailer (6) next to it with loaded CNG storage modules (5) in line with stalls II and III.

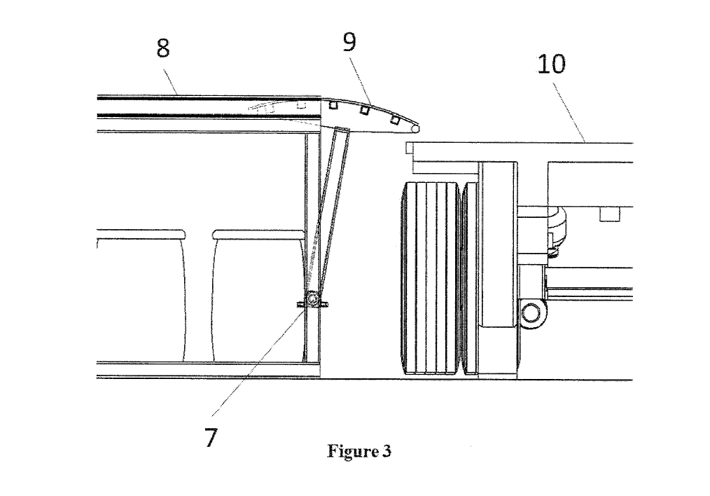

FIG. 3 shows the bridge's roller surface (9) that extends a track's roller surface (8) to the trailer deck (10). The bridge rotates about an axis (7). This enables a user to adjust the position of the bridge to be in contact with the trailer deck (10) to enable a CNG storage module (5) to be rolled from the trailer deck (10), to the bridge's roller surface (9), and finally to the track's roller surface (8) during unloading operation. Conversely, during loading operation a CNG storage module would initially be on the track's roller surface (8) and be rolled over the bridge's roller surface (9) to the trailer deck (10).

Additionally, FIG. 3 shows that the track's roller surface (8) is higher than the trailer deck (10). This is to ensure a sufficient contact point between the bridge (4) and the trailer deck (10). A locking mechanism can be used to fully constrain the bridge to enable it to withstand the lateral loads during loading and unloading operations. Alternatively, the track's roller surface (8) can have rollers or a sliding surface instead of the CNG storage module (5) having wheels.

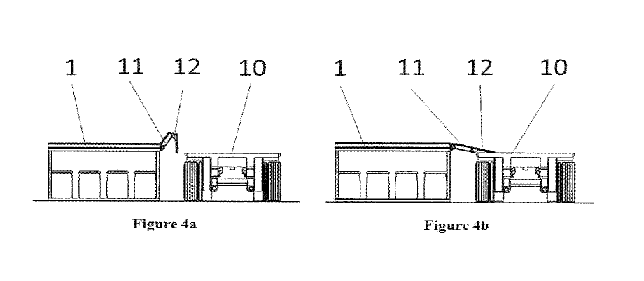

FIGS. 4a and 4b show a second bridge design that is made of two parts (11) and (12), and has two points of rotation. In FIG. 4a the two piece bridge design isn't extended, which shows the points of rotation. In FIG. 4b, the two piece bridge design is fully extended and resting on the trailer deck (10). In this state, parts 11 and 12 are locked from rotating when they experience downward vertical loads such as a CNG storage module would exert, though are free to rotate when an upward vertical load is experienced. In this embodiment, the track (1) and trailer deck (10) did not change from the previous design.

System Process

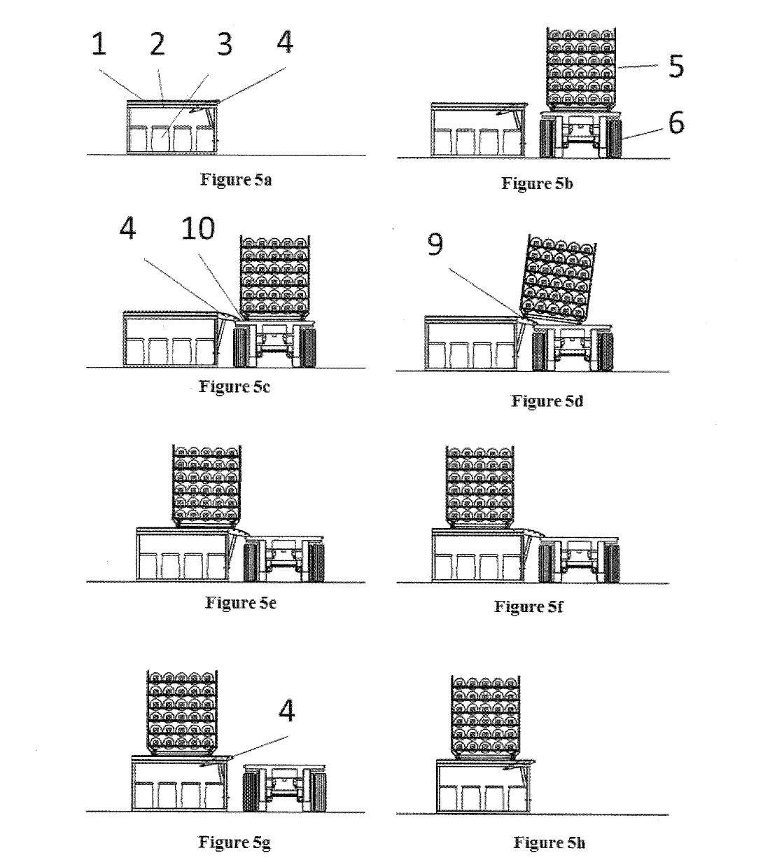

FIGS. 5A-5h show the system process of unloading a CNG storage module (5) off a trailer (6). FIG. 5a shows the environment prior to a loaded trailer (6) parking next to it, such as in FIG. 5b. Once the user positions the trailer (6) in an appropriate location with respect to the structure (2), the bridge (4) is rotated clockwise until it comes into contact with the trailer deck (10) shown in FIG. 5c. The alternate bridge (11 and 12) shown in FIGS. 4a and 4b could be used here instead.

Next, the CNG storage module is pulled or pushed so it starts to roll over the bridge's roller surface (9) as shown in FIG. 5d. From here the CNG storage module (5) is pulled or pushed to its final location on top of tracks (1) as shown in FIG. 5f. Then, the bridge (4) is rotated counterclockwise to no longer be in contact with the trailer deck (10) and an appropriate clearance is created between the bridge (4) and trailer (6) to not result in a collision when the trailer is towed away as shown in FIG. 5g.

Finally, the trailer exits, leaving the CNG storage modules (5) on the structure (2) as shown in FIG. 5h.

The process of loading a CNG storage module from the structure onto an empty trailer would follow these steps in reverse. According to various embodiments, the system and apparatus is designed to be effective at both loading and unloading the CNG storage modules.

Although various embodiments have been described with respect to CNG, such embodiments and alternative embodiments may alternatively be used with any other suitable compressed or pressurized fluid without deviating from the scope of the present invention (e.g., compressed natural gas (CNG), adsorbed natural gas (ANG), compressed forms of other types of gases, pressurized liquid natural gas (LNG), pressurized liquid propane (LP), etc.).

The foregoing description does not represent an exhaustive list of all possible implementations consistent with this disclosure or of all possible variations of the implementations described. A number of implementations have been described. Nevertheless, it will be understood that various modifications may be made with departing from the spirit and scope of the systems, devices, methods and techniques described here. For example, various forms of the flows shown above may be used, with steps re-ordered, added or removed.

What is claimed is:

1. An apparatus comprising:
two bilateral tracks that a compressed gas storage module can roll on;
bridges that rotate about an axis that connects the two bilateral tracks to a trailer deck; and
a supporting structure that elevates the two bilateral tracks and bridges to a height that is equal to or higher than a height of the trailer deck.

2. An apparatus comprising:
two bilateral tracks that a compressed gas storage module can roll on;
bridges that rotate about two axes where the second joint has a stop when the two legs are in line, and connects the two bilateral tracks to a trailer deck; and
a supporting structure that elevates the two bilateral tracks and bridges to a height that is equal to or higher than a height of the trailer deck.

3. A method comprising:
rolling a compressed gas storage module from a trailer deck to a bridge's roller surface and then to a track's roller surface.

4. The method of claim 3, wherein the compressed gas storage module comprises a compressed natural gas storage module.

5. A method comprising:
rolling a compressed gas storage module from a track's roller surface to a bridge's roller surface and then to a trailer deck.

6. The method of claim 5, wherein the compressed gas storage module comprises a compressed natural gas storage module.
